(19) United States
(12) Patent Application Publication
(10) Pub. No.: US 2021/0402974 A1
(43) Pub. Date: Dec. 30, 2021

(54) HYBRID ELECTRIC VEHICLE AND METHOD OF CONTROLLING THE SAME

(71) Applicants: Hyundai Motor Company, Seoul (KR); Kia Motors Corporation, Seoul (KR)

(72) Inventors: Jea Mun Lee, Incheon (KR); Joon Young Park, Seoul (KR); Dong Jun Shin, Hwaseong (KR)

(21) Appl. No.: 17/115,109

(22) Filed: Dec. 8, 2020

(30) Foreign Application Priority Data
Jun. 25, 2020 (KR) 10-2020-0077843

(51) Int. Cl. B60W 20/12; B60W 20/11; B60W 20/20

(52) U.S. Cl. CPC B60W 20/12; B60W 20/11; B60W 2554/20; B60W 2400/00; B60W 2510/0676; B60W 20/20

(57) ABSTRACT

A hybrid electric vehicle control mode includes receiving traffic light information including signal information and distance information of a traffic light ahead under an EV mode entry condition. The method includes predicting the duration of the EV mode based on the received traffic light information, predicting the temperature of a coolant in the EV mode according to the predicted duration of the EV mode, and comparing the predicted temperature of the coolant with a reference temperature at which a full automatic temperature control (FATC) unit requests starting of an engine. The EV mode is entered when the predicted temperature of the coolant is greater than the reference temperature.

### CROSS-REFERENCE TO RELATED APPLICATION(S)

This application claims the benefit of Korean Patent Application No. 10-2020-0077843, filed on Jun. 25, 2020, which is hereby incorporated by reference as if fully set forth herein.

### BACKGROUND

### Field of the Disclosure

The present disclosure relates to a hybrid electric vehicle and a method of controlling the same, and more particularly to a hybrid electric vehicle and a method of controlling the same capable of predicting the duration of an electric vehicle (EV) mode based on traffic light information and estimating the temperature of a coolant corresponding thereto, thereby minimizing entry into a series hybrid electric vehicle (HEV) mode for indoor heating.

### Discussion of the Related Art

In general, a hybrid electric vehicle (HEV) is a vehicle that uses two types of power sources, the two types of power sources being an engine and an electric motor. Such a hybrid electric vehicle produces optimum output and torque based on harmonious operation of the two power sources, namely the engine and the motor. In particular, in a hybrid electric vehicle that employs a parallel-type or transmission-mounted-electric-drive (TMED)-type hybrid system, in which an electric motor and an engine clutch (EC) are mounted between an engine and a transmission, the output of the engine and the output of the motor may be simultaneously transmitted to a driving shaft.

Under general conditions, the hybrid electric vehicle is driven in an electric vehicle (EV) mode, in which the hybrid electric vehicle travels using only the electric motor, at the beginning of acceleration. Thereafter, when greater driving force is required, the driving mode is switched to a hybrid electric vehicle (HEV) mode, in which power is generated by driving both the electric motor and the engine. The HEV mode, in which the electric motor and the engine operate together, may be divided into a parallel HEV mode and a series HEV mode depending on a main power source.

In the parallel HEV mode of the HEV mode, the power of the engine functions as driving force. However, in the series HEV mode, the engine is driven with low load and thus the power of the engine is used to generate electricity. The parallel HEV mode exhibit higher efficiency than the series HEV mode. However, since the TMED-type hybrid electric vehicle is generally not equipped with a torque converter, it is difficult to maintain the on state of the engine below a predetermined vehicle speed, unlike a general internal combustion engine vehicle. Thus, the TMED-type hybrid electric vehicle is driven in the series HEV mode when traveling at a low speed below a predetermined speed.

In recently developed vehicles, a full automatic temperature control (FATC) unit is responsible for air-conditioning operation. In hybrid electric vehicles, as necessary, the FATC unit performs control to heat indoor air using engine coolant heated by the heat of the engine. In particular, when the temperature of the engine coolant is less than the temperature necessary for the FATC unit to perform indoor heating, the FATC unit requests a hybrid control unit (HCU) to start the engine. Accordingly, the HCU starts the engine, and selects one of the parallel mode and the series mode depending on the situation.

FIG. 1 shows graphs for explaining problems of HEV mode switching control when the vehicle stops due to a traffic light under traveling conditions requiring indoor heating. FIG. 1 shows a vehicle speed graph, a graph indicating a change in the value of an accelerator position sensor (APS), a driving mode graph, and a coolant temperature graph. The horizontal axis of each of these graphs represents time.

A first section S1 is a section in which the vehicle is traveling at a speed at which the vehicle is capable of traveling in the parallel mode. In the parallel mode, the power of the engine acts as driving force, and thus the temperature of the engine coolant may increase due to the heat of the engine. As the parallel mode driving time increases, the temperature of the coolant increases, and the engine coolant, the temperature of which is greater than a reference temperature, is capable of being used as an energy source for indoor heating.

A second section S2 is a section in which the vehicle is decelerated to stop due to a stop signal of the traffic light, e.g. a red light. As the operation of the accelerator pedal stops for deceleration and the vehicle speed decreases, the driving mode is switched to the EV mode. Accordingly, the operation of the engine stops, and thus the temperature of the coolant drops.

A third section S3 is a section in which the engine is driven for indoor heating in the state in which the vehicle stops or travels at a low speed. When the vehicle is stopping or traveling at a low speed, the engine stops, and thus the temperature of the coolant decreases. When the temperature of the coolant is equal to or less than a predetermined level, heating performance required by the driver may not be secured. Accordingly, when the temperature of the coolant decreases to a first reference value (FATC On Temp.), the FATC unit requests the HCU to drive the engine. The HCU drives the engine to increase the temperature of the coolant at the request of the FATC unit. When the engine is started, one of the parallel mode and the series mode may be selected. However, when the vehicle is in the third section S3, i.e. in the state of traveling at a low speed or stopping, the vehicle enters the series HEV mode.

A fourth section S4 is a section in which the series HEV mode for indoor heating is terminated and the vehicle stands by until the signal of the traffic light is switched to a go signal, e.g. a green light. When the temperature of the coolant increases and reaches a second reference value (FATC Off Temp.), at which indoor heating is possible, due to the series HEV mode, the FATC unit requests the HCU to stop the engine. The HCU stops the engine to terminate the series HEV mode at the request of the FATC unit. Since the engine stops operating, the temperature of the coolant decreases. A fifth section S5 is a section in which the vehicle resumes traveling in response to the go signal of the traffic light and is traveling at a speed at which the vehicle is capable of traveling in the parallel mode.

As described above, when the temperature of the coolant decreases under traveling conditions requiring indoor heating, the engine needs to be driven for indoor heating. When the engine is started for indoor heating, it is advantageous to drive the vehicle in the parallel HEV mode in terms of improvement of fuel efficiency and an increase in the temperature of the coolant. However, in the state in which the vehicle is traveling at a low speed or is stopped due to, for example, a traffic light, it is difficult to satisfy the vehicle speed at which the vehicle is capable of entering the parallel HEV mode, so the vehicle needs to be driven in the series HEV mode.

In particular, in an extremely cold environment, the request to drive the engine by the FATC unit may be maintained for a long time, or may be frequently made. Accordingly, the vehicle is driven in the series HEV mode to adjust the temperature of the coolant, rather than the EV mode, thereby causing deterioration in fuel efficiency.

### SUMMARY

Accordingly, the present disclosure is directed to a hybrid electric vehicle and a method of controlling the same that substantially obviate one or more problems due to limitations and disadvantages of the related art. An object of the present disclosure is to provide a hybrid electric vehicle and a method of controlling the same capable of minimizing driving in a series HEV mode for indoor heating under traveling conditions requiring indoor heating, thereby minimizing deterioration in fuel efficiency. However, the objects to be accomplished by the exemplary embodiments are not limited to the above-mentioned objects, and other objects not mentioned herein will be clearly understood by those skilled in the art to which the exemplary embodiments pertain from the following description.

In order to accomplish the above and other objects, a method of controlling a hybrid electric vehicle according to an exemplary embodiment of the present disclosure may include receiving traffic light information including signal information and distance information of a traffic light ahead under an EV mode entry condition, predicting the duration of the EV mode based on the received traffic light information, predicting the temperature of a coolant in the EV mode according to the predicted duration of the EV mode, comparing the predicted temperature of the coolant with a reference temperature at which a full automatic temperature control (FATC) unit requests starting of an engine, and entering the EV mode when the predicted temperature of the coolant is greater than the reference temperature.

In addition, a hybrid electric vehicle according to an exemplary embodiment of the present disclosure may include a first controller configured to receive traffic light information including signal information and distance information of a traffic light ahead and a second controller configured to predict the duration of an EV mode based on the received traffic light information, to predict the temperature of a coolant in the EV mode according to the predicted duration of the EV mode, to compare the predicted temperature of the coolant with a reference temperature at which a full automatic temperature control (FATC) unit requests starting of an engine, and to enter the EV mode when the predicted temperature of the coolant is greater than the reference temperature.

### BRIEF DESCRIPTION OF THE DRAWINGS

The accompanying drawings, which are included to provide a further understanding of the disclosure and are incorporated in and constitute a part of this application, illustrate exemplary embodiment(s) of the disclosure and together with the description serve to explain the principle of the disclosure. In the drawings:

FIG. 1 shows graphs for explaining problems of HEV mode switching for indoor heating in a conventional hybrid electric vehicle according to the prior art;

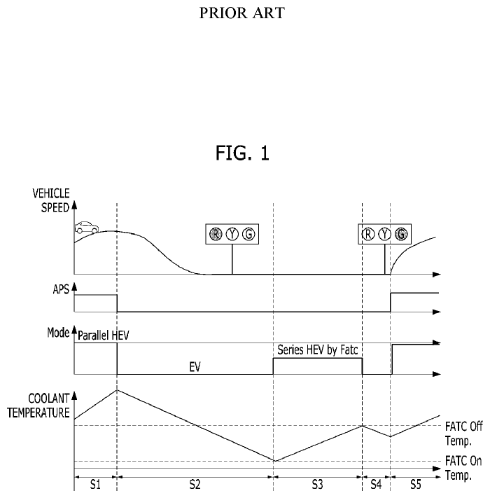

FIG. 2 shows an example of the structure of a powertrain of a hybrid electric vehicle to which exemplary embodiments of the present disclosure are applicable;

FIG. 3 is a block diagram showing an example of a control system of a hybrid electric vehicle to which exemplary embodiments of the present disclosure are applicable;

FIG. 4 is a flowchart schematically showing a control process of a hybrid electric vehicle according to an exemplary embodiment of the present disclosure;

FIG. 5 is a graph for explaining a method of predicting the duration of an EV mode based on traffic light information in a hybrid electric vehicle according to an exemplary embodiment of the present disclosure;

FIG. 6 is a diagram for explaining a method of predicting the temperature of a coolant in a hybrid electric vehicle according to an exemplary embodiment of the present disclosure;

FIG. 7 is a flowchart showing a control process of a hybrid electric vehicle according to a first exemplary embodiment of the present disclosure;

FIG. 8 is a flowchart showing a control process of a hybrid electric vehicle according to a second exemplary embodiment of the present disclosure; and

FIG. 9 shows graphs for explaining the effects of HEV mode switching for indoor heating in a hybrid electric vehicle of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings so that those skilled in the art may easily carry out the exemplary embodiments. The present disclosure may, however, be embodied in many different forms, and should not be construed as being limited to the exemplary embodiments set forth herein. In the drawings, parts irrelevant to the description of the present disclosure will be omitted for clarity. Like reference numerals refer to like elements throughout the specification.

Throughout the specification, when a certain part “includes” or “comprises” a certain component, this indicates that other components are not excluded, and may be further included unless otherwise noted. The same reference numerals used throughout the specification refer to the same constituent elements.

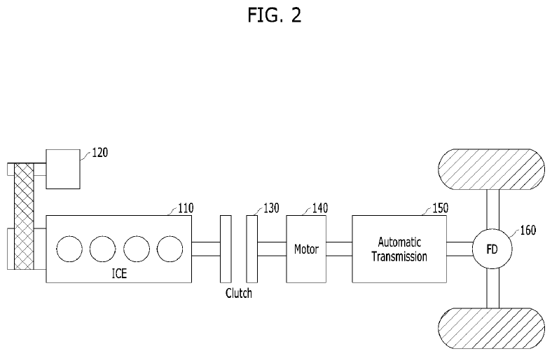

FIG. 2 shows an example of the structure of a powertrain of a hybrid electric vehicle to which exemplary embodiments of the present disclosure are applicable. FIG. 2 illustrates a powertrain of a hybrid electric vehicle employing a parallel-type hybrid system, in which an electric motor (or a drive motor) 140 and an engine clutch (EC) 130 are mounted between an internal combustion engine (ICE) 110 and a transmission 150.

In such a vehicle, when a driver engages an accelerator pedal after starting the vehicle, the motor 140 may first be driven using the power of a battery in the state in which the engine clutch 130 is open, and then the power of the motor may be transmitted to the wheels via the transmission 150 and a final drive (FD) 160 to rotate the wheels (i.e. the EV mode). When greater driving force is required as the vehicle is accelerated, an auxiliary motor (or a starting/generating motor) 120 may operate to drive the engine 110.

When the rotational speeds of the engine 110 and the motor 140 become equal, the engine clutch 130 is locked, with the result that both the engine 110 and the motor 140, or only the engine 110, drives the vehicle (i.e. transition from the EV mode to the HEV mode). When a predetermined engine OFF condition is satisfied, for example, when the vehicle is decelerated, the engine clutch 130 is open, and the engine 110 is stopped (i.e. transition from the HEV mode to the EV mode). In addition, when the hybrid electric vehicle is braked, the driving force of the wheels is converted into electrical energy, and the battery is charged with the electrical energy, which is referred to as recovery of braking energy or regenerative braking.

The starting/generating motor 120 operates as a starter motor when the engine is started, and operates as a generator when the rotational energy of the engine is collected after the engine is started or when the engine is turned off. Therefore, the starting/generating motor 120 may be referred to as a “hybrid starter generator (HSG)”, or may also be referred to as an “auxiliary motor” in some cases.

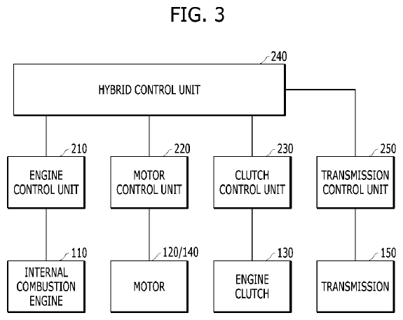

The relationships between controllers in the vehicle to which the powertrain described above is applied are shown in FIG. 3. FIG. 3 is a block diagram showing an example of a control system of a hybrid electric vehicle to which exemplary embodiments of the present disclosure are applicable.

Referring to FIG. 3, in a hybrid electric vehicle to which exemplary embodiments of the present disclosure are applicable, the internal combustion engine 110 may be operated by an engine controller 210, and the torque of the starting/generating motor 120 and the motor 140 may be operated by a motor control unit (MCU) 220. The engine clutch 130 may be operated by a clutch controller 230. In particular, the engine controller 210 may be referred to as an engine management system (EMS). In addition, the transmission 150 may be operated by a transmission controller 250. In some cases, a controller configured to operate the starting/generating motor 120 and a controller configured to operate the motor 140 may be provided separately from each other.

Each of the controllers may be connected to a hybrid control unit (HCU) 240, which is an upper-level controller configured to execute the overall process of mode switching, and may provide information necessary for engine clutch control at the time of switching driving modes or shifting gears and/or information necessary for engine stop control to the hybrid controller 240, or may perform an operation in response to a control signal under the operation of the hybrid controller 240. More specifically, the hybrid controller 240 may be configured to determine whether to perform the mode-switching operation depending on the traveling state of the vehicle.

For example, the hybrid controller may be configured to determine the time at which to open the engine clutch 130. When the engine clutch 130 is open, the hybrid controller may be configured to perform hydraulic pressure control (in the case of a wet engine clutch) or torque capacity control (in the case of a dry engine clutch). Further, the hybrid controller 240 may be configured to determine the state of the engine clutch (e.g., lock-up, slip, open, etc.) and adjust the time at which to stop injecting fuel into the engine 110. In addition, the hybrid controller may be configured to transmit a torque command for adjusting the torque of the starting/generating motor 120 to the motor controller 220 to control engine stop, thereby controlling recovery of the rotational energy of the engine. In addition, the hybrid controller 240 may be configured to determine the mode-switching condition and operate the lower-level controllers to perform mode switching at the time of mode-switching control according to the exemplary embodiments of the present disclosure, which will be described later.

Of course, it will be apparent to those skilled in the art that the connection relationships between the control units and the functions/division of the control units described above are illustrative and are not limited by the names thereof. For example, the hybrid controller 240 may be implemented such that the function thereof is provided by any one of the controllers other than the hybrid controller 240 or such that the function thereof is distributed and provided by two or more of the other controllers.

In addition, although the transmission-mounted-electric-drive (TMED)-type parallel hybrid electric vehicle has been described above with reference to FIGS. 2 and 3, this is merely illustrative, and the exemplary embodiments of the present disclosure are not limited to any specific type of hybrid electric vehicle. The exemplary embodiments of the present disclosure are applicable to any type of hybrid electric vehicle, so long as it is possible to realize indoor heating using heat generated by operation of the engine.

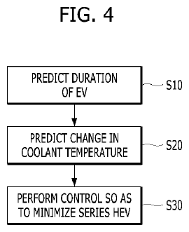

Hereinafter, a more efficient control method according to an exemplary embodiment of the present disclosure will be described on the basis of the above-described structure of the vehicle. FIG. 4 is a flowchart schematically showing a control process of a hybrid electric vehicle according to an exemplary embodiment of the present disclosure. Referring to FIG. 4, in an exemplary embodiment of the present disclosure, the duration of the EV mode may be predicted based on traffic light information (S10), and a reduction in the temperature of the coolant may be estimated (S20). When the series HEV mode is expected to occur based on the estimated temperature of the coolant, the occurrence of the series HEV mode may be prevented or minimized (S30).

When the duration of the EV mode is predicted based on the traffic light information in step S10, the traffic light information may include at least one of a signal change period of a traffic light ahead, the currently displayed signal ahead of the current route, the remaining distance to a traffic light ahead, the remaining time period of the currently displayed signal, next signal display information, or traffic light location information. In addition to the traffic light information, traffic information, such as information on the road to a traffic light ahead, congestion in each section, and an average speed in each section, may be further included. It may be assumed that the traffic light information and the traffic information are received through an audio/video/navigation (AVN) system, but this is merely illustrative.

The exemplary embodiments of the present disclosure are not limited to any specific control unit or system, so long as it is possible to perform wireless communication with an entity providing the traffic information. For example, the traffic light information may be acquired from a telematics center via a telematics modem or through a data center/server/cloud connection using a wireless communication module, and the vehicle speed information may be acquired using various sensors mounted within the vehicle. The duration of the EV mode may be predicted based on the traffic light information.

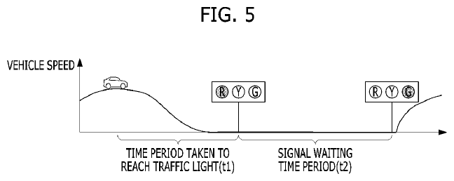

FIG. 5 is a graph for explaining a method of predicting the duration of the EV mode based on the traffic light information according to an exemplary embodiment of the present disclosure. Referring to FIG. 5, the duration of the EV mode may be calculated using a time period t1, taken for the vehicle to reach a traffic light, and a signal waiting time period t2, remaining until a go signal of the traffic light, e.g. a green light, is turned on.

The time period t1 required to reach the traffic light may be calculated by substituting the remaining distance d1 to the traffic light and the vehicle speed into Equation 1 below.

t1=d1/vehicle speed Equation 1

wherein, t1 represents the time period required to reach the traffic light, and d1 represents the remaining distance to the traffic light.

The signal waiting time period t2 may be calculated by substituting the remaining time period of the current signal and the remaining time period of the next signal into Logical Formula 1 below.

If t1>t_now,

Predicted Signal=Next Signal,

t2=t_next−t_now

Else

Predicted Signal=Current Signal

t2=t_now−t1 Logical Formula 1

wherein, t_now represents the remaining time period of the current signal, and t_next represents the remaining time period of the next signal.

If the predicted signal according to the above Logical Formula 1 is ‘stop’, the duration of the EV mode t_EV may be calculated as follows: t_EV=t1+t2, and if the predicted signal is ‘go’, the duration of the EV mode t_EV may be calculated as follows: t_EV=0. When the duration of the EV mode is predicted, step S20, i.e. the process of estimating the temperature of the coolant, may be performed.

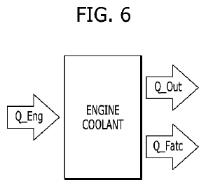

FIG. 6 is a diagram for explaining a method of predicting the temperature of the coolant in a hybrid electric vehicle according to an exemplary embodiment of the present disclosure. Referring to FIG. 6, a change in the temperature of the engine coolant may be calculated using the amount of heat received from the engine Q_{engine}, the amount of heat discharged to the atmosphere Q_{Out}, and the amount of heat used for indoor heating Q_{Fatc}. This is expressed using Equation 2 below.

$$Δ T = \frac{{Q}_{engine} - ( {Q}_{out} + {Q}_{Fatc} )}{CM} \qquad Equation 2$$

wherein Q_{engine} represents the amount of heat received from the engine, Q_{Out} represents the amount of heat discharged to the atmosphere (Q_{Out}=f(external air temperature, engine coolant temperature), Q_{Fatc} represents the amount of heat used for indoor heating (Q_{Fatc}=f(set temperature, indoor temperature), C represents the thermal capacity of the engine coolant, and M represents the mass of the engine coolant.

The predicted coolant temperature T_{Final} using ΔT calculated through the above Equation 2 may be calculated through Equation 3 below, in which a change in the amount of heat during the EV mode is reflected in the initial coolant temperature Tᵢₙᵢₜᵢₐₗ.

T_{Final}=Tᵢₙᵢₜᵢₐₗ+∫₀^{t}^{_{EV}}ΔTdt Equation 3

When the predicted coolant temperature T_{Final} is obtained through the above calculation process, whether the FATC unit will request driving of the engine at the time of entry into the EV mode may be determined. In other words, when the predicted coolant temperature T_{Final} is equal to or less than the first reference value (FATC On Temp.) necessary for the FATC unit to perform indoor heating, it may be predicted that the FATC unit will request driving of the engine at the time of entry into the EV mode, and thus it may be possible to perform control to minimize operation in the series HEV mode.

As a control method for minimizing operation in the series HEV mode when the FATC unit requests for engine driving, an engine stop time may be delayed as much as possible before entering the EV mode, or the heating performance of the FATC unit may be reduced. Alternatively, these two methods may be used together.

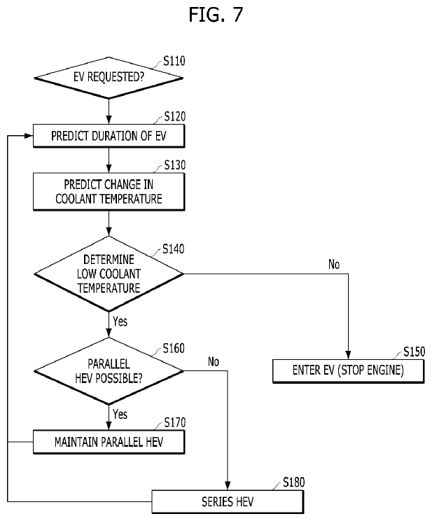

FIG. 7 is a flowchart showing a control process of a hybrid electric vehicle according to a first exemplary embodiment of the present disclosure. Specifically, FIG. 7 shows an embodiment in which an engine stop time is delayed as much as possible to minimize operation in the series HEV mode.

Referring to FIG. 7, when switching to the EV mode is requested (S110), the duration of the EV mode may be predicted based on traffic light information (S120). The duration of the EV mode may be predicted by calculating the time period t1, taken for the vehicle to decelerate and reach a traffic light, and the signal waiting time period t2, remaining until a go signal of the traffic light, e.g. a green light, is turned on.

When the duration of the EV mode is predicted, a change in the temperature of the coolant may be predicted (S130). The predicted coolant temperature T_{Final} may be calculated by reflecting a change in the amount of heat during the EV mode in the initial coolant temperature Tᵢₙᵢₜᵢₐₗ. Thereafter, whether the calculated predicted coolant temperature T_{Final} is a low coolant temperature that is equal to or less than the first reference value (FATC On Temp.) necessary for the FATC unit to perform indoor heating may be determined (S140).

In response to determining that the predicted coolant temperature T_{Final} is not a low coolant temperature, the temperature of the engine coolant is sufficient to maintain indoor heating even if the EV mode is activated. Accordingly, the engine may be stopped, and the EV mode may be activated (S150). In response to determining in step S140 that the predicted coolant temperature T_{Final} is a low coolant temperature, entry into the EV mode may be postponed, and whether the vehicle is capable of being driven in the parallel HEV mode may be determined (S160). In general, when the vehicle is traveling at a predetermined speed or greater, the vehicle is capable of being driven in the parallel HEV mode.

When the vehicle is capable of being driven in the parallel HEV mode, the parallel HEV mode may be maintained (S170). The process returns to step S120 to predict the duration of the EV mode. When the vehicle is not capable of being driven in the parallel HEV mode, the series HEV mode may be maintained (S180). The process returns to step S120 to predict the duration of the EV mode.

As described above, in the first exemplary embodiment of the present disclosure, when switching to the EV mode is requested, a predicted coolant temperature T_{Final} may be calculated based on traffic light information before the engine is stopped, and whether the predicted coolant temperature T_{Final} is a low coolant temperature may be determined. In response to determining that the predicted coolant temperature T_{Final} is a low coolant temperature, the HEV mode may be maintained, and in response to determining that the predicted coolant temperature T_{Final} is sufficiently high, the driving mode may be switched to the EV mode. Accordingly, when the vehicle stops or travels at a low speed due to a traffic light, it may be possible to prevent deterioration in fuel efficiency due to entry into the series HEV mode for adjusting the temperature of the coolant at the request of the FATC unit.

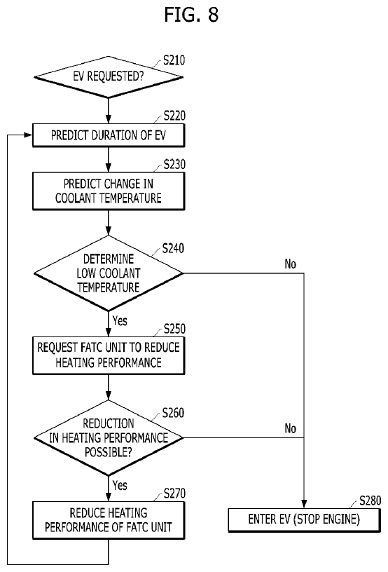

FIG. 8 is a flowchart showing a control process of a hybrid electric vehicle according to a second exemplary embodiment of the present disclosure. Specifically, FIG. 8 shows an exemplary embodiment of reducing heating performance to minimize operation in the series HEV mode. Referring to FIG. 8, when switching to the EV mode is requested (S210), the duration of the EV mode may be predicted based on traffic light information (S220). The duration of the EV mode may be predicted by calculating the time period t1, taken for the vehicle to decelerate and reach a traffic light, and the signal waiting time period t2, remaining until a go signal of the traffic light, e.g. a green light, is turned on.

When the duration of the EV mode is predicted, a change in the temperature of the coolant may be predicted (S230). The predicted coolant temperature T_{Final} may be calculated by reflecting a change in the amount of heat during the EV mode in the initial coolant temperature Tᵢₙᵢₜᵢₐₗ. Thereafter, whether the calculated predicted coolant temperature T_{Final} is a low coolant temperature that is equal to or less than the first reference value (FATC On Temp.) necessary for the FATC unit to perform indoor heating may be determined (S240).

In response to determining that the predicted coolant temperature T_{Final} is not a low coolant temperature, the temperature of the engine coolant is sufficient to maintain indoor heating even if the EV mode is activated. Accordingly, the engine may be stopped, and the EV mode may be activated (S250). In response to determining in step S240 that the predicted coolant temperature T_{Final} is a low coolant temperature, entry into the EV mode may be postponed, and a reduction in the heating performance may be requested to the FATC unit (S250). In other words, a request may be transmitted for a reduction in the reference temperature of the coolant necessary for indoor heating or a reduction in the heating temperature.

When a reduction in the heating performance of the FATC unit is impossible, the engine may be stopped and the EV mode may be activated (S280). When a reduction in the heating performance of the FATC unit is possible (S260), the reference temperature of the coolant or the heating temperature may be adjusted to reduce the heating performance (S270). The process returns to step S220 to predict the duration of the EV mode.

As described above, in the second exemplary embodiment of the present disclosure, when switching to the EV mode is requested, a predicted coolant temperature T_{Final} may be calculated based on traffic light information before the engine is stopped, and whether the predicted coolant temperature T_{Final} is a low coolant temperature may be determined. In response to determining that the predicted coolant temperature T_{Final} is a low coolant temperature, heating performance may be reduced, thereby preventing deterioration in fuel efficiency due to entry into the series HEV mode for adjusting the temperature of the coolant at the request of the FATC unit.

The control process according to the exemplary embodiments of the present disclosure may be implemented such that the hybrid control unit acquires traffic light information from the AVN system and executes a program pre-stored in an internal memory in order to predict the duration of the EV mode or estimate the temperature of the coolant. In addition, the heating setting may be acquired from the air-conditioning controller (e.g. the FATC unit). In addition, information regarding the current coolant temperature may be acquired from the engine controller, and a request to start the engine may be performed in the form of transmitting a command to the engine controller. According to another aspect of this exemplary embodiment, the engine controller may be configured to perform the above-described control logic, or a separate controller may be provided to perform the control logic.

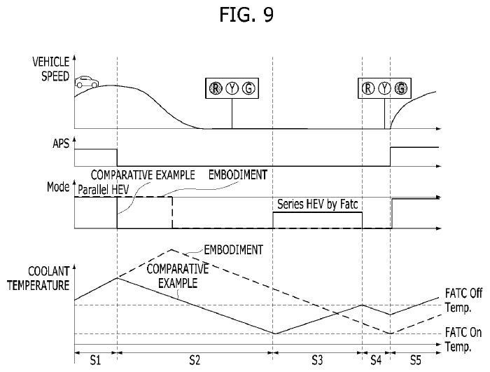

FIG. 9 shows graphs for explaining the effects of HEV mode switching for indoor heating in the hybrid electric vehicle of the present disclosure. FIG. 9 shows a vehicle speed graph, a graph indicating a change in the value of an accelerator position sensor (APS), a driving mode graph, and a coolant temperature graph. The horizontal axis of each of these graphs represents time.

A first section S1 is a section in which the vehicle is traveling at a speed at which the vehicle is capable of traveling in the parallel mode. In the parallel mode, the power of the engine acts as driving force, and thus the temperature of the engine coolant may increase due to the heat of the engine. As the parallel mode driving time increases, the temperature of the coolant increases, and the engine coolant, the temperature of which is greater than a reference temperature, is capable of being used as an energy source for indoor heating.

A second section S2 is a deceleration section in which the vehicle is decelerated and travels to a traffic light. If the driver stops operating the accelerator pedal for deceleration, the speed of the vehicle decreases. Conventionally, when the speed of the vehicle decreases, the engine is stopped to enter the EV mode, and the temperature of the coolant decreases from the time at which the EV mode is activated. However, the present disclosure predicts the duration of the EV mode based on traffic light information, and predicts a change in the temperature of the coolant based on the duration of the EV mode.

In response to determining that the predicted coolant temperature T_{Final} is a low coolant temperature that is equal to or less than the first reference value (FATC On Temp.) necessary for the FATC unit to perform indoor heating, entry into the EV mode may be postponed, and the parallel HEV mode may be maintained. Accordingly, the temperature of the coolant continuously increases. The present disclosure may predict the duration of the EV mode and a change in the temperature of the coolant based thereon in the state in which the parallel HEV mode is maintained. In response to determining that the predicted coolant temperature T_{Final} is not a low coolant temperature, the engine may be stopped, and the EV mode may be activated. The temperature of the coolant decreases from the time at which the EV mode is activated.

A third section S3 and a fourth section S4 are sections in which the vehicle waits for switching of the signal of the traffic light to a go signal. Conventionally, because the temperature of the coolant decreases to a low coolant temperature while the vehicle waits for a traffic signal, the FATC unit requests driving of the engine. Accordingly, the HCU enters the series HEV mode to increase the temperature of the coolant. In contrast, according to the present disclosure, the parallel HEV mode may be maintained until the temperature of the coolant sufficiently increases based on the signal waiting time period, and thereafter the EV mode may be activated, thereby preventing the temperature of the coolant from decreases to a low coolant temperature while the vehicle waits for a traffic signal. As a result, it may be possible to maintain the EV mode while the vehicle waits for a traffic signal.

A fifth section S5 is a section in which the vehicle resumes traveling in response to the go signal of the traffic light and is traveling at a speed at which the vehicle is capable of traveling in the parallel mode. As described above, the present disclosure is capable of minimizing operation in the series HEV mode for indoor heating when a vehicle travels at a low speed or stops due to, for example, a traffic light.

The present disclosure may be implemented as code that may be written on a non-transitory computer-readable recording medium and thus read by a computer system. The non-transitory computer-readable recording medium includes all types of recording devices in which data that may be read by a computer system are stored. Examples of the computer-readable recording medium include a Hard Disk Drive (HDD), a Solid-State Disk (SSD), a Silicon Disk Drive (SDD), a Read-Only Memory (ROM), a Random Access Memory (RAM), a Compact Disk ROM (CD-ROM), a magnetic tape, a floppy disc, and an optical data storage.

As is apparent from the above description, a hybrid electric vehicle according to at least one exemplary embodiment of the present disclosure configured as described above may minimize driving in the series HEV mode under traveling conditions requiring indoor heating, thereby improving fuel efficiency. In particular, the duration of the EV mode and a change in the temperature of the coolant are predicted using traffic light information, based on which the time period during which a vehicle is driven in the parallel HEV mode is increased or the heating performance of the FATC unit is reduced, thus minimizing driving in the series HEV mode.

However, the effects achievable through the disclosure are not limited to the above-mentioned effects, and other effects not mentioned herein will be clearly understood by those skilled in the art from the above description.

It will be apparent to those skilled in the art that various changes in form and details may be made without departing from the spirit and essential characteristics of the disclosure set forth herein. Accordingly, the above detailed description is not intended to be construed to limit the disclosure in all aspects and to be considered by way of example. The scope of the disclosure should be determined by reasonable interpretation of the appended claims and all equivalent modifications made without departing from the disclosure should be included in the following claims.

What is claimed is:

1. A method of controlling a hybrid electric vehicle, comprising:
receiving, by a controller, traffic light information including signal information and distance information of a traffic light ahead under an electric vehicle (EV) mode entry condition;
predicting, by the controller, a duration of an EV mode based on the received traffic light information;
predicting, by the controller, a temperature of a coolant in the EV mode according to the predicted duration of the EV mode;
comparing, by the controller, the predicted temperature of the coolant with a reference temperature at which a full automatic temperature control (FATC) unit requests starting of an engine; and
entering, by the controller, the EV mode when the predicted temperature of the coolant is greater than the reference temperature.

2. The method according to claim 1, further comprising:
determining, by the controller, whether entry into a first hybrid electric vehicle (HEV) mode, using a power of the engine as a driving force, is possible when the predicted temperature of the coolant is equal to or less than the reference temperature; and
entering, by the controller, the first HEV mode in response to determining that entry into the first HEV mode is possible.

3. The method according to claim 2, further comprising:
entering, by the controller, a second HEV mode, using the power of the engine to generate electricity, in response to determining that entry into the first HEV mode is impossible.

4. The method according to claim 3, wherein the first HEV mode includes a parallel mode, and wherein the second HEV mode includes a series mode.

5. The method according to claim 1, further comprising:
requesting, by the controller, the FATC unit to reduce at least one of the reference temperature or a heating setting temperature in response to determining that the predicted temperature of the coolant is equal to or less than the reference temperature.

6. The method according to claim 1, wherein the receiving the traffic light information includes receiving at least one of a signal change period of a traffic light ahead, a currently displayed signal ahead of a current route, a remaining distance to a traffic light ahead, a remaining time period of a currently displayed signal, next signal display information, or traffic light location information.

7. The method according to claim 1, wherein the predicting the duration of the EV mode based on the received traffic light information includes calculating a sum of a time period, taken for a vehicle to decelerate based on the traffic light information and reach a traffic light, and a signal waiting time period, remaining until a go signal of the traffic light is turned on.

8. The method according to claim 7, wherein the predicting the duration of the EV mode based on the received traffic light information includes calculating the signal waiting time period using a current signal, a remaining time period of the current signal, a next signal, and a remaining time period of the next signal.

9. The method according to claim 1, wherein the predicting the temperature of the coolant in the EV mode includes adding a coolant temperature that is to be reduced by heating when the engine is not operated during the duration of the EV mode to a reference coolant temperature when the engine is operated.

10. A non-transitory computer-readable recording medium having recorded thereon a program for executing the method of claim 1.

11. A hybrid electric vehicle, comprising:
a first controller configured to receive traffic light information including signal information and distance information of a traffic light ahead; and
a second controller configured to predict a duration of an electric vehicle (EV) mode based on the received traffic light information, to predict a temperature of a coolant in the EV mode according to the predicted duration of the EV mode, to compare the predicted temperature of the coolant with a reference temperature at which a full automatic temperature control (FATC) unit requests starting of an engine, and to enter the EV mode when the predicted temperature of the coolant is greater than the reference temperature.

12. The hybrid electric vehicle according to claim 11, wherein the second controller is configured to determine whether entry into a first hybrid electric vehicle (HEV) mode, using a power of the engine as a driving force, is possible in response to determining that the predicted temperature of the coolant is equal to or less than the reference temperature, and enter the first HEV mode in response to determining that entry into the first HEV mode is possible.

13. The hybrid electric vehicle according to claim 12, wherein the second controller is configured to enter a second HEV mode, using the power of the engine to generate electricity, in response to determining that entry into the first HEV mode is impossible.

14. The hybrid electric vehicle according to claim 11, wherein the FATC unit is configured to perform indoor heating using the coolant, and request the second controller to start the engine in response to determining that the temperature of the coolant is equal to or less than the reference temperature.

15. The hybrid electric vehicle according to claim 14, wherein the second controller is configured to request the FATC unit to reduce at least one of the reference temperature or a heating setting temperature in response to determining that the predicted temperature of the coolant is equal to or less than the reference temperature.

16. The hybrid electric vehicle according to claim 11, wherein the traffic light information includes at least one of a signal change period of a traffic light ahead, a currently displayed signal ahead of a current route, a remaining distance to a traffic light ahead, a remaining time period of a currently displayed signal, next signal display information, or traffic light location information.

17. The hybrid electric vehicle according to claim 11, wherein the second controller is configured to predict the duration of the EV mode by calculating a sum of a time period, taken for a vehicle to decelerate based on the traffic light information and reach a traffic light, and a signal waiting time period, remaining until a go signal of the traffic light is turned on.

18. The hybrid electric vehicle according to claim 17, wherein the second controller is configured to calculate the signal waiting time period using a current signal, a remaining time period of the current signal, a next signal, and a remaining time period of the next signal.

19. The hybrid electric vehicle according to claim 11, wherein the second controller is configured to predict the temperature of the coolant in the EV mode by adding a coolant temperature that is to be reduced by heating when the engine is not operated during the duration of the EV mode to a reference coolant temperature when the engine is operated.
